(19) United States
(12) Patent Application Publication
(10) Pub. No.: US 2026/0197148 A1
(43) Pub. Date: Jul. 9, 2026

(54) METHOD FOR DETERMINING SWITCH PERIOD BETWEEN BANDS, AND COMMUNICATION DEVICE

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/550,664

(22) Filed: Feb. 26, 2026

Related U.S. Application Data
(63) Continuation of application No. PCT/CN2023/128711, filed on Oct. 31, 2023.

(30) Foreign Application Priority Data
Oct. 27, 2023 (WO) PCT/CN2023/127358

(51) Int. Cl. H04L 5/00

(52) U.S. Cl. CPC H04L 5/0098; H04L 5/0048

(57) ABSTRACT

A method for determining a switch period between bands and a communication device. The method is performed by a terminal device. The terminal device supports a first band combination and a plurality of high-order band combinations corresponding to the first band combination. The method includes determining a first switch period, wherein the first switch period is a switch period between a first band and a second band in the first band combination.

### CROSS-REFERENCE TO RELATED APPLICATION

The present disclosure is a continuation the International Application No. PCT/CN 2023/128711, filed Oct. 31, 2023, which claims priority to International Application No. PCT/CN 2023/127358, filed Oct. 27, 2023, the entire disclosures of which are incorporated herein by reference.

### TECHNICAL FIELD

Embodiments of the present disclosure relate to the field of communication technologies, and in particular, relate to a method for determining a switch period between bands, and a communication device.

### RELATED ART

A terminal device typically supports a large number of band combinations, including a high-order band combination (e.g., a band combination A+B+C) and a low-order band combination (e.g., a band combination A+B). To simplify the capability reporting of the terminal device, the terminal device may only report capability information for the high-order band combination while omitting capability information for the low-order band combination.

### SUMMARY

Embodiments of the present disclosure provide a method for determining a switch period between bands, and a communication device. The technical solutions are as follows:
According to some embodiments of the present disclosure, a method for determining a switch period between bands is provided. The method is performed by a terminal device, wherein the terminal device supports a first band combination and a plurality of high-order band combinations corresponding to the first band combination. The method includes: determining a first switch period, wherein the first switch period is a switch period between a first band and a second band in the first band combination.

According to some embodiments of the present disclosure, a communication device is provided. The communication device supports a first band combination and a plurality of high-order band combinations corresponding to the first band combination. The communication device includes a processor and a memory storing one or more computer programs, wherein the one or more programs, when loaded and run by the processor, cause the processor to determine a first switch period, wherein the first switch period is a switch period between a first band and a second band in the first band combination.

According to some embodiments of the present disclosure, a communication device is provided. The communication device includes a processor and a memory storing one or more computer programs, wherein the one or more programs, when loaded and run by the processor, cause the processor to determine a first switch period to be used by a terminal device, wherein the terminal device supports a first band combination and a plurality of high-order band combinations corresponding to the first band combination; and the first switch period is a switch period between a first band and a second band in the first band combination.

### BRIEF DESCRIPTION OF DRAWINGS

FIG. 1 is a schematic diagram of a network architecture according to some embodiments of the present disclosure;

FIG. 2 is a schematic diagram of band coverage according to some embodiments of the present disclosure;

FIG. 3 is a schematic diagram of band switching according to some embodiments of the present disclosure;

FIG. 4 is a schematic diagram of band switching according to some embodiments of the present disclosure;

FIG. 5 is a schematic diagram of a switch period for band switching according to some embodiments of the present disclosure;

FIG. 6 is a schematic diagram of a relationship between a switch period of a terminal device and a radio frequency (RF) architecture according to some embodiments of the present disclosure;

FIG. 7 is a flowchart of a method for determining a switch period between bands according to some embodiments of the present disclosure;

FIG. 8 is a schematic diagram of an ambiguity switch period of a low-order band combination according to some embodiments of the present disclosure;

FIG. 9 is a flowchart of a method for determining a switch period between bands according to some embodiments of the present disclosure;

FIG. 10 is a schematic diagram of an RF chain corresponding to a band combination A+B+C indicated by a network device according to some embodiments of the present disclosure;

FIG. 11 is a schematic diagram of an RF chain corresponding to a band combination A+B+D indicated by a network device according to some embodiments of the present disclosure;

FIG. 12 is a schematic diagram of a problem that a switch period indicated by a network device is inconsistent with actual capabilities of a terminal device according to some embodiments of the present disclosure;

FIG. 13 is a flowchart of a method for determining a switch period between bands according to some embodiments of the present disclosure;

FIG. 14 is a flowchart of a method for determining a switch period between bands according to some embodiments of the present disclosure;

FIG. 15 is a flowchart of a method for determining a switch period between bands according to some embodiments of the present disclosure;

FIG. 16 is a flowchart of a method for determining a switch period between bands according to some embodiments of the present disclosure;

FIG. 17 is a flowchart of a method for determining a switch period between bands according to some embodiments of the present disclosure;

FIG. 18 is a block diagram of an apparatus for determining a switch period between bands according to some embodiments of the present disclosure;

FIG. 19 is a block diagram of an apparatus for determining a switch period between bands according to some embodiments of the present disclosure;

FIG. 20 is a schematic structural diagram of a terminal device according to some embodiments of the present disclosure; and

FIG. 21 is a schematic structural diagram of a network device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skill in the art understand that, with the evolution of the network architecture and the emergence of new service scenarios, the technical solutions according to the embodiments of the present disclosure are also applicable to similar technical problems.

Referring to FIG. 1, a schematic diagram of a network architecture according to some embodiments of the present disclosure is illustrated. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5^{th} generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 includes various forms of macro base stations, micro base stations, relay stations, access points, and the like. The name of the device with functionality of an access network device varies in systems employing different radio access technologies. For example, the device is referred to as a gNodeB or a gNB in the 5G NR system. With the evolution of communication technologies, the name “access network device” may change. For the convenience of description, the above apparatuses providing the wireless communication functionality for the terminal devices 13 are collectively referred to as the access network device in the embodiments of the present disclosure.

Typically, a plurality of terminal devices 13 are provided, and one or more terminal devices 13 may be arranged in a cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices, that is, the terminal device and the UE mentioned in the embodiments of the present disclosure have the same meaning. The access network devices 14 communicate with the core network devices using an air interface technology, such as an NG interface in the 5G NR system. The access network devices 14 communicate with the terminal devices 13 using an air interface technology, such as a Uu interface.

The terminal devices 13 (for example, the in-vehicle device and another device, such as another in-vehicle device, a mobile phone, or a road side unit (RSU)) may communicate with each other over a direct communication interface (for example, a ProSe communication 5 (PC5) interface). Accordingly, the communication link established based on the direct communication interface may be referred to as a direct link or a sidelink (SL). The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The “5G NR system” in the embodiments of the present disclosure may also be referred to as a 5G system or an NR system, but those skilled in the art can understand the meaning thereof. The technical solutions according to the embodiments of the present disclosure are applicable to the 5G NR system, and also to evolved systems of the 5G NR system.

Before description of the technical solutions of the present disclosure, some background technical knowledge involved in the present disclosure is first explained. The following related technologies, as optional solutions, may be combined with the technical solutions according to the embodiments of the present disclosure in any manner, all of which fall within the scope of protection of the embodiments of the present disclosure. The embodiments of the present disclosure include at least some of the following content.

### 1. Transmit (Tx) Switching

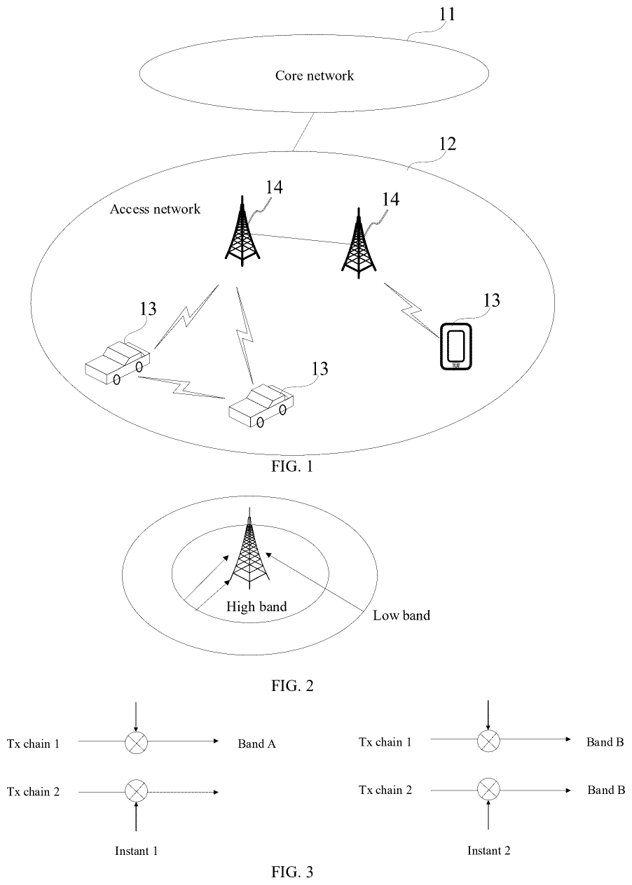

Under the same Tx power, space propagation loss is lower and cell coverage is generally larger in a low band, as illustrated in FIG. 2. In contrast, in a high band, because space propagation loss is larger, cell coverage is smaller under the same Tx power, but the bandwidth and capacity are larger, and generally uplink multiple-in multiple-output (MIMO) may be achieved.

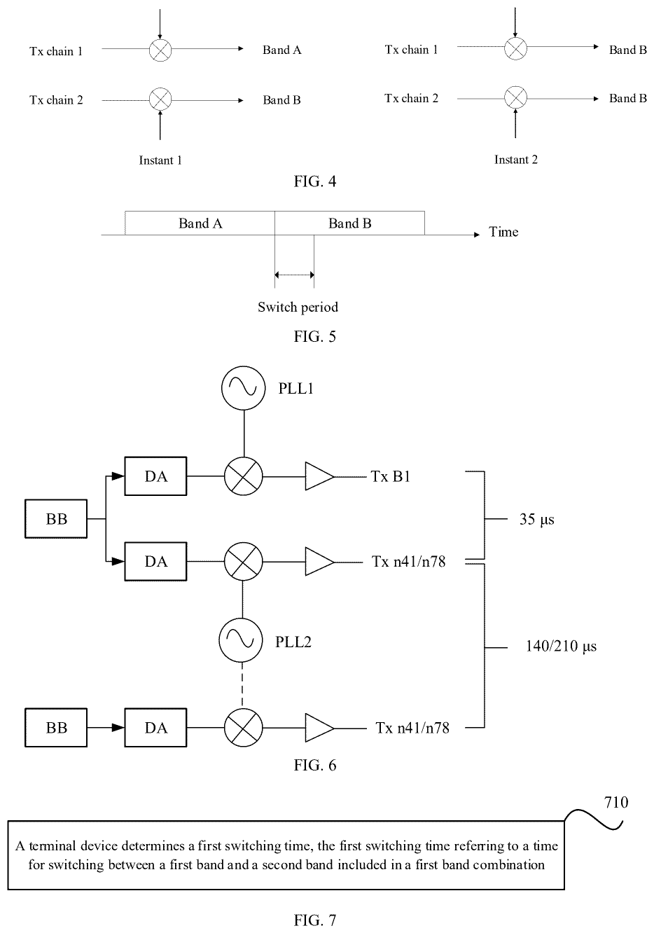

Therefore, one way to take full advantages of the wide coverage at the low band and the larger capacity in the high band is to combine the two bands for use. However, in terms of hardware, a terminal device generally may only support two concurrent chains. In a case where the low band occupies one Tx chain, the high band may only use the other Tx chain. Consequently, the advantage of the combination of the low band and the high band may not be used. Therefore, uplink Tx switching is an effective implementation, that is, transmission is switched between a low band and a high band. As illustrated in FIG. 3, transmission is performed at a low band (band A) at instant 1, and transmission is performed at a high band (band B) at instant 2. Alternatively, as illustrated in FIG. 4, simplex transmission is performed at the low band (band A) and at the high band (band B) at instant 1, and duplex transmission is performed at the high band (band B) at instant 2. In this way, the characteristics of wide coverage at the low band and the MIMO capability and larger bandwidth at the high band can be fully used.

### 2. Switch Period

In the Tx switching scenario, the terminal device needs to adjust the operating frequency and parameter setting of the Tx chain, which takes some time. Therefore, when the Tx chain of the terminal device is switched from band A to band B, seamless switching may not be achieved and the switching takes some time for adjustment, as illustrated in FIG. 5. Generally, the terminal device reports the time for adjustment based on a band pair. Subsequent to receiving the reporting, the base station knows how long it takes for adjustment for the terminal device to switch on the band pair, and the terminal device may not perform effective transmission during this period of time.

A switch period of a terminal device is usually directly related to an RF architecture. As illustrated in FIG. 6, in this architecture, the terminal device is provided with two phase-locked loops (PLLs) that may simultaneously generate two operating carrier frequencies for up-conversion of the terminal device. For two bands with a switching relationship, such as Tx B1 and Tx n41/n78 in FIG. 6, independent PLLs are used for their respective up-conversion (i.e., PLL 1 is used by Tx B1, PLL 2 is used by Tx n41/n78). The two PLLs may operate independently during switching from Tx B1 to Tx n41/n78 or from Tx n41/n78 to Tx B1, with a relatively short switch period typically 35 μs. However, in FIG. 6, during switching from Tx n41 to Tx n78, since these two bands share the same PLL 2 for carrier frequency adjustment, the operating frequency of PLL 2 first needs to be adjusted from Tx n41 to Tx n78 prior to the subsequent switching operation. In this case, as the switching of the operating frequency of the PLL generally requires a relatively long period, the switching from Tx n41 to Tx n78 takes approximately 140 μs or 210 μs.

### 3. Reporting of Switch Period Capability

Typically, a terminal device supports a large number of band combinations, including a high-order band combination (e.g., a band combination A+B+C) and a low-order band combination (e.g., a band combination A+B). To simplify the capability reporting of the terminal device, the terminal device may only report capability information for the high-order band combination while omitting capability information for the low-order band combination. In this way, upon receiving the high-order band combination information reported by the terminal device, the network device knows the capabilities for the corresponding low-order band combination, thereby simplifying the processing of terminal capability information by the network device.

However, in terms of switch period capability, a potential scenario arises where a switch period (e.g., 35μs) of the band pair (or band combination) A+B reported by the terminal device in the high-order band combination A+B+C is different from a switch period (e.g., 140 μs) of the band pair A+B reported in another high-order band combination, for example, A+B+D. In this scenario, during configuration of the low-order band combination A+B by the network device for the terminal device, the actual switch period for the terminal device (whether 35 μs or 140 μs) becomes difficult to be determined.

The embodiments of the present disclosure provide a method for determining a switch period between bands. This method enables effective determination of the switch period for band switching in a case where a terminal device reports different switch periods in a plurality of higher-order band combinations for the same lower-order band combination, thereby ensuring normal band switching operations.

Referring to FIG. 7, a flowchart of a method for determining a switch period between bands according to some embodiments of the present disclosure is illustrated. The method is performed by a terminal device. The method includes step 710.

In step 710, the terminal device determines a first switch period, wherein the first switch period is a switch period between a first band and a second band in a first band combination.

In some embodiments, the terminal device supports the first band combination and a plurality of high-order band combinations corresponding to the first band combination.

In some embodiments, in a plurality of high-order band combinations reported by the terminal device to a network device, switch periods corresponding to the first band combination are different. For example, as illustrated in FIG. 8, the terminal device reports to the network device that the terminal device supports high-order band combinations A+B+C and A+B+D, wherein A+B is the first band combination. In the high-order band combination A+B+C, a switch period between band A and band B reported by the terminal device is 35 μs. However, in the high-order band combination A+B+D, the switch period between band A and band B reported by the terminal device is 140 μs. In this case, a value of the first switch period is ambiguous, and the terminal device needs to determine an appropriate first switch period to ensure the normal switching between band A and band B.

It should be noted that, relative to the high-order band combination, the first band combination constitutes a low-order band combination. Therefore, in the embodiments of the present disclosure, the first band combination may also be referred to as a low-order band combination, which is not elaborated herein.

In some embodiments, the first switch period is indicated by a network device. For example, the network device determines one switch period as the first switch period from switch periods between the first band and the second band reported by the terminal device, and indicates the determined switch period to the terminal device. For example, the network device determines a maximum switch period, from the switch periods supported by the terminal device, as the first switch period and indicates the maximum switch period to the terminal device. For example, the switch periods supported by the terminal device include 35 μs, 140 μs and 210 μs, and the network device determines the first switch period to be 210 μs.

In some embodiments, the first switch period is autonomously determined by the terminal device. For example, the terminal device determines the first switch period based on its own implementation. For example, in a case where the first switch period is 35 μs, the terminal device fails to complete the switching between the first band and the second band. In this case, the terminal device determines the first switch period to be 140 μs or 210 μs. Conversely, in a case where the first switch period is 35 μs, the terminal device is capable of completing the switching between the first band and the second band. In this case, the terminal device determines the first switch period to be 3 5μs.

In some embodiments, step 710 may be implemented in the following schemes.
Scheme 1: The first switch period is indicated by a network device.

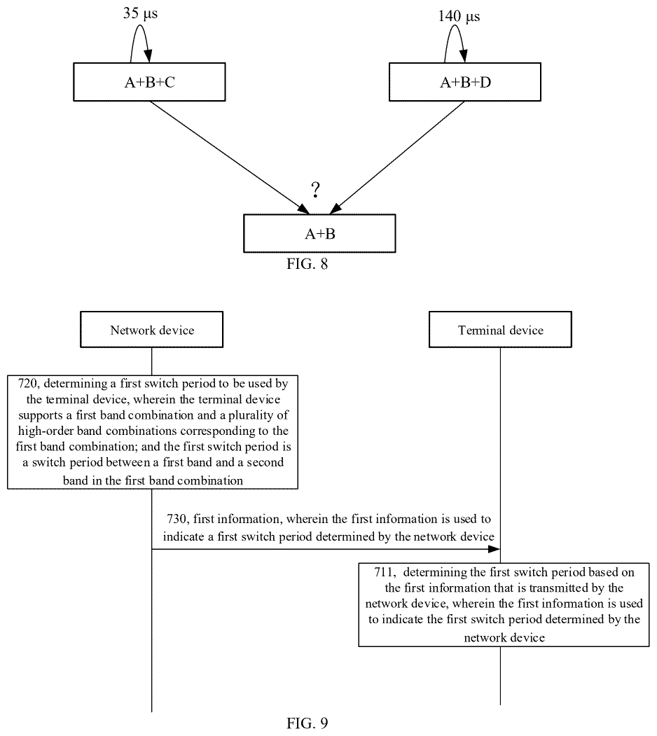

As illustrated in FIG. 9, Scheme 1 may involve at least one of step 720, step 730, o step 711.

In step 720, the network device determines a first switch period to be used by the terminal device, wherein the terminal device supports a first band combination and a plurality of high-order band combinations corresponding to the first band combination. The first switch period is a switch period between a first band and a second band in the first band combination.

In step 730, the network device transmits first information to the terminal device, wherein the first information is used to indicate a first switch period determined by the network device.

Correspondingly, the terminal device receives the first information that is transmitted by the network device.
Step 710 may be implemented as step 711.

In step 711, the terminal device determines the first switch period based on the first information that is transmitted by the network device, wherein the first information is used to indicate the first switch period determined by the network device.

In some embodiments, in a case where the terminal device supports the first switch period indicated by the first information, the terminal device determines the first switch period indicated by the first information as the first switch period.

In some embodiments, in a case where the terminal device does not support the first switch period indicated by the first information, the terminal device determines the first switch period based on the implementation of the terminal device.

In some embodiments, the first information is used to indicate a first high-order band combination from the plurality of high-order band combinations, the first switch period determined by the network device is the same as a second switch period, and the second switch period is a switch period between the first band and the second band in the first high-order band combination. The terminal device determines the first switch period based on the first band combination indicated by the first information.

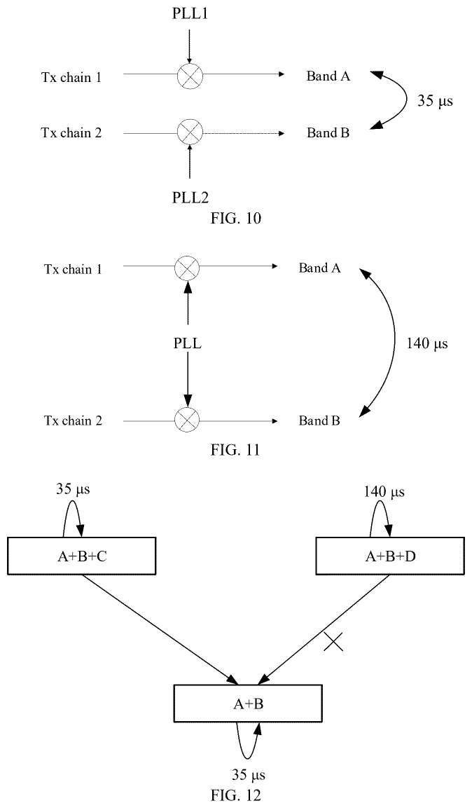

For example, as illustrated in FIG. 8, in a case where the first information indicates a band combination A+B+C, the terminal device determines the first switch period to be a switch period between band A and band B as indicated in the band combination A+B+C. The terminal device then adapts its RF chain to an RF state corresponding to the band combination A+B+C, such as a state where band A and band B employ respective independent PLLs (PLL 1 and PLL 2) to perform switching, as illustrated in FIG. 10.

For example, as illustrated in FIG. 8, in a case where the first information indicates a band combination A+B+D, the terminal device determines the first switch period to be a switch period between band A and band B as indicated in the band combination A+B+D. The terminal device then adapts its RF chain to an RF state corresponding to the band combination A+B+D, such as a state where each of band A and band B employs a shared PLL to perform switching, as illustrated in FIG. 11.

In some embodiments, the first information may explicitly indicate the first high-order band combination or implicitly indicate the first high-order band combination, which is not limited in the present disclosure.

In some embodiments, the first information indicates the first switch period by explicitly indicating the first high-order band combination. For example, the first information includes a field, and this field is used to indicate that the first switch period is a switch period indicated in the first high-order band combination.

In some embodiments, the first information indicates the first switch period by implicitly indicating the first high-order band combination. For example, the first information indicates the first high-order band combination in the plurality of high-order band combinations. The terminal device then determines that the first switch period indicated by the network device is a switch period indicated in the first high-order band combination.

In some embodiments, the first information is used to indicate the first switch period determined by the network device from a plurality of candidate switch periods.

In some embodiments, the plurality of candidate switch periods include 35 μs, 140 μs, and 210 μs.

In some embodiments, for a low-order band combination, the number of corresponding high-order band combinations may be very large. Although the embodiments of the present disclosure mostly use the band combinations A+B+C and A+B+D as examples, in practical scenarios, other high-order band combinations such as A+B+E, A+B+F, A+B+G may exist. Direct indication of a high-order band combination to the terminal device may result in relatively high complexity. However, directly indicating a switch period to the terminal device is a relatively simpler approach, as the switch periods currently supported by terminal devices are limited to three specifications: 35 μs, 140 μs and 210 μs.

With the development of technology, the number of switch periods supported by terminal devices may also increase. For example, with the improvement of capabilities of terminal devices, the switch periods supported by the terminal devices may be further shortened. Alternatively, due to an increase in the number of RF chains in the terminal devices, the switch periods required by the terminal devices may become longer, which is not limited in the present disclosure. The embodiments herein are illustrated by using an example where the plurality of candidate switch periods include 35 μs, 140 μs, and 210 μs.

The above method allows the network device to indicate the first switch period for the terminal device, thereby resolving the ambiguity in the switch period that arises when a plurality of high-order band combinations fall back to a low-order band combination.

Although the above method is simple for the implementation of the network device, a potential problem is present: The terminal device operating in a low-order band combination may not support the switch period indicated by the network device, which may lead to inconsistencies between the network device and the terminal device regarding the switch period.

Referring to the content in “3. Reporting of Switch Period Capability,” to reduce the reporting complexity, the terminal device may only report the terminal capability information for the high-order band combination, instead of reporting the communication capabilities for the low-order band combination. As illustrated in FIG. 12, for a low-order band combination A+B, its corresponding high-order band combination may be either A+B+C or A+B+D. In a case where the capabilities for the band combination A+B are the same as those for the band A+the band B within the band combination A+B+C, the terminal device may omit the separate reporting of the capability information for the band combination A+B. However, in a case where the capability information for the band A+the band B within the high-order band combination A+B+D is different from that under the combination A+B, issues may be caused in Scheme 1. To solve this problem, the present disclosure also proposes Scheme 2 and Scheme 3.
Scheme 2: The terminal device reports a preferred first switch period to the network device.

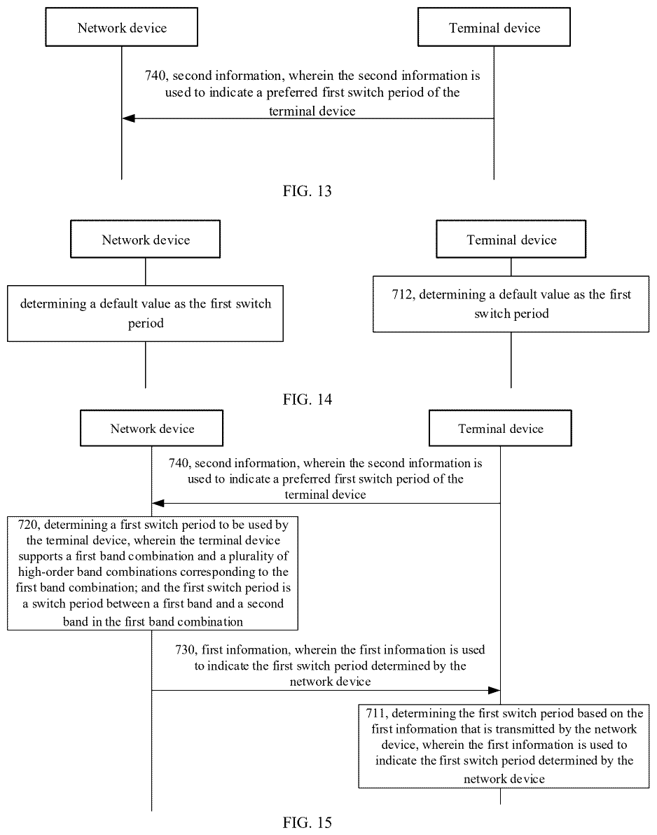

As illustrated in FIG. 13, Scheme 2 involves step 740.

In step 740, the terminal device transmits second information to the network device, wherein the second information is used to indicate a preferred first switch period of the terminal device.

Correspondingly, the network device receives the second information that is transmitted by the terminal device.

In some embodiments, the second information is used to indicate a second high-order band combination from the plurality of high-order band combinations, the preferred first switch period of the terminal device is the same as a third switch period, and the third switch period is a switch period between the first band and the second band in the second high-order band combination.

For example, as illustrated in FIG. 12, for a low-order band combination A+B, its corresponding high-order band combination may be either A+B+C or A+B+D. In a case where the capabilities for the band combination A+B are the same as those for the band A +the band B within the band combination A+B+C, the second information may be used to indicate the high-order band combination A+B+C. In a case where the capabilities for the band combination A+B are the same as those for the band A+the band B in the band combination A+B+D, the second information may be used to indicate the high-order band combination A+B+D. The network device may determine the preferred first switch period of the terminal device based on the high-order band combination indicated in the second information.

In some embodiments, the second information is used to indicate the preferred first switch period of the terminal device from a plurality of candidate switch periods.

In some embodiments, to reduce the complexity of the network device processing the second information, the second information may also directly indicate the preferred first switch period of the terminal device. For example, the preferred first switch period of the terminal device indicated by the second information may be one of 35 μs, 140 μs, or 210 μs.

The above method allows the terminal device to report its preferred first switch period to the network device, thereby effectively avoiding inconsistencies between the terminal device and the network device regarding the first switch period.
Scheme 3: The first switch period is determined using a default value.

In Scheme 1 and Scheme 2, the first switch period is determined based on the communication between the terminal device and the network device. However, the problem of how the terminal device determines the first switch period remains unresolved in a case where the network device does not indicate the first switch period or in a case where the terminal device does not report the capability information for the low-order band combination.

As illustrated in FIG. 14, in Scheme 3, step 710 may be implemented as step 712.

In step 712, the terminal device determines a default value as the first switch period.

Correspondingly, the network device determines the default value as the first switch period to be used by the terminal device.

In some embodiments, the default value is a maximum switch period between the first band and the second band in the plurality of high-order band combinations. For example, as illustrated in FIG. 12, for a low-order band combination A+B, its corresponding high-order band combination may be either A+B+C or A+B+D, where a switch period of A+B corresponding to A+B+C is 35 μs, and a switch period of A+B corresponding to A+B+D is 140 μs. In this case, both the terminal device and the network device determine the first switch period to be 140 μs.

In some embodiments, the default value is a maximum switch period in a plurality of candidate switch periods. For example, the plurality of candidate switch periods include 35 μs, 140 μs and 210 μs. In this case, both the terminal device and the network device determine the first switch period to be 210 μs.

In some embodiments, the method for determining the default value may be predefined or preconfigured, or may be indicated by the network device to the terminal device, which is not limited in the present disclosure.

The above method allows both the terminal device and the network device to determine the first switch period using a default value, such that the first switch period is determined without communication between the terminal device and the network device, and the consistency between the terminal device and the network device regarding the first switch period is also ensured.

The technical solutions according to the embodiments of the present disclosure provides a method for determining a first switch period used for band switching in a low-order band combination in a case where the terminal device reports different switch periods in a plurality of high-order band combinations for the same low-order band combination. This ensures that band switching is performed normally to guarantee communication quality.

In the above embodiments, three schemes are provided for determining the first switch period. New schemes for determining the first switch period may be acquired via combinations based on Scheme 1 to Scheme 3. Several possible combination schemes are exemplarily described hereinafter according to the embodiments of the present disclosure.
Scheme 4: Combination of Scheme 1 and Scheme 2

As illustrated in FIG. 15, Scheme 4 may involve at least one of step 740, step 720, step 730, or step 711.

In step 740, the terminal device transmits second information to the network device, wherein the second information is used to indicate a preferred first switch period of the terminal device.

Correspondingly, the network device receives the second information that is transmitted by the terminal device.

In some embodiments, the second information is used to indicate a second high-order band combination in the plurality of high-order band combinations, the preferred first switch period of the terminal device is the same as a third switch period, and the third switch period is a switch period between the first band and the second band in the second high-order band combination.

In some embodiments, the second information is used to indicate the preferred first switch period of the terminal device from a plurality of candidate switch periods.

In step 720, the network device determines a first switch period to be used by the terminal device.

In some embodiments, the first switch period determined by the network device is greater than or equal to the preferred first switch period of the terminal device.

In some embodiments, the network device determines the preferred first switch period of the terminal device indicated in the second information as the first switch period to be used by the terminal device. For example, in a case where the preferred first switch period of the terminal device indicated in the second information is 35 μs, the network device determines that the first switch period to be used by the terminal device is 35 μs.

In some embodiments, the first switch period that is to be used by the terminal device and determined by the network device is greater than the preferred first switch period of the terminal device. For example, in a case where the preferred first switch period of the terminal device indicated in the second information is 35 μs, the network device determines that the first switch period to be used by the terminal device is 140 μs or 210 μs.

The terminal device may omit the capability information for low-order band combinations during reporting of switch period capabilities, as illustrated in FIG. 12. In a case where the terminal device reports that switch periods between band A and band B in high-order band combinations A+B+C and A+B+D are 35 μs and 140 μs respectively, the terminal device further reports that a switch period between band A and band B is 35 μs. In this case, during the determination of the first switch period, the network device may determine that the switch period between band A and band B is 35 μs.

Reporting capability information separately for each low-order band combination results in relatively high complexity of signaling reporting for terminal devices. To reduce the complexity, one approach is for the network device to consider that the terminal device follows the switch period of the high-order band combination in a case where the terminal device does not separately report the switch period capability information for the low-order band combination. Alternatively, in a case where a plurality of high-order band combinations exist and switch periods corresponding to a low-order band combination in these high-order band combinations are different, the network device considers that the terminal device supports the switch period corresponding to the low-order band combination indicated in each of the plurality of high-order band combinations, or considers that the switch period of the low-order band combination is a default value.

In some embodiments, in a case where the terminal device does not transmit the second information to the network device, the network device determines that the terminal device supports the switch period between the first band and the second band in any one of the plurality of high-order band combinations.

In some embodiments, in a case where the terminal device does not transmit the second information to the network device, the first switch period is determined based on a default value.

In some embodiments, the default value may be predefined or preconfigured, or may be determined by the network device, which is not limited in the present disclosure. In an example, the default value may be 35 μs, 140 μs or 210 μs. In another example, the default value may be the maximum one of switch periods corresponding to the low-order band combination in the high-order band combinations reported by the terminal device. For example, in a case where switch periods of A+B corresponding to the high-order band combinations A+B+C and A+B+D reported by the terminal device are 35 μs and 140 μs respectively, the default value is 140 μs.

The above method allows the network device to determine the first switch period to be used by the terminal device based on the preferred first switch period of the terminal device reported by the terminal device, or alternatively allows the first switch period to be determined based on a default value. This effectively avoids inconsistencies between the terminal device and the network device regarding the first switch period.

In step 730, the network device transmits first information to the terminal device, wherein the first information is used to indicate a first switch period determined by the network device.

Correspondingly, the terminal device receives the first information that is transmitted by the network device.
Step 710 may be implemented as step 711.

In step 711, the terminal device determines the first switch period based on the first information that is transmitted by the network device, wherein the first information is used to indicate the first switch period determined by the network device.

According to the above method, the terminal device reports its preferred first switch period to the network device, and the network device indicates a first switch period to be used by the terminal device based on the preferred first switch period of the terminal device. This avoids situations where the terminal device does not support the first switch period indicated by the network device, thereby avoiding inconsistencies between the terminal device and the network device regarding the first switch period.

### Scheme 5: Combination of Scheme 1 and Scheme 3

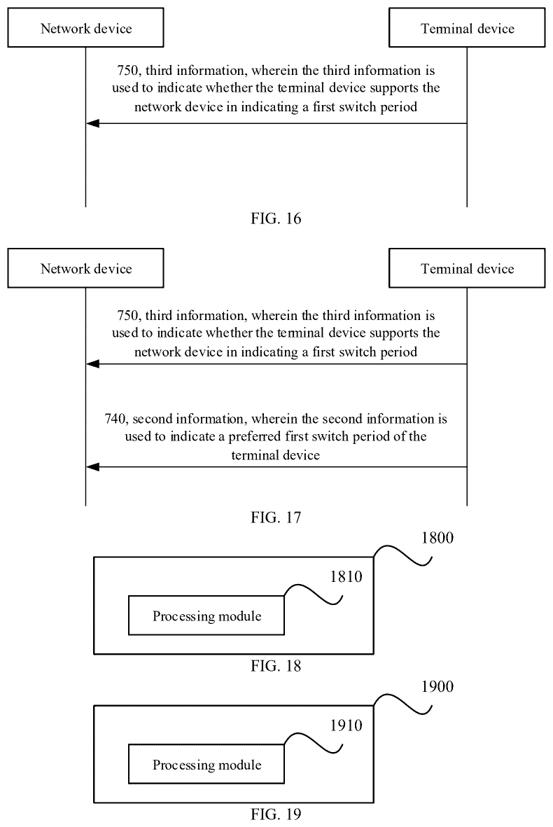

As illustrated in FIG. 16, Scheme 5 may involve step 750.

In step 750, the terminal device transmits third information to the network device, wherein the third information is used to indicate whether the terminal device supports the network device in indicating a first switch period.

Correspondingly, the network device receives the third information that is transmitted by the terminal device.

In other words, the terminal device transmits third information to the network device, wherein the third information is used to indicate whether the terminal device supports Scheme 1.

In some embodiments, in a case where the third information indicates that the terminal device supports the network device in indicating the first switch period, the first switch period is determined based on first information that is transmitted by the network device, wherein the first information is used to indicate a first switch period determined by the network device.

In some embodiments, in a case where the third information indicates that the terminal device supports Scheme 1, the first switch period is determined using Scheme 1. That is, the first switch period is determined according to the flowchart illustrated in FIG. 9.

In some embodiments, in a case where the terminal device does not transmit the third information to the network device, or in a case where the third information indicates that the terminal device does not support the network device to indicate the first switch period, the first switch period is determined based on a default value.

In some embodiments, in a case where the terminal device does not transmit the third information to the network device, or in a case where the third information indicates that the terminal device does not support Scheme 1, the first switch period is determined using Scheme 3. That is, both the terminal device and the network device determine the first switch period using the default value.

In some embodiments, in a case where the terminal device does not transmit the third information to the network device, the network device considers that the terminal device supports the network device in indicating the first switch period.

In some embodiments, in a case where the terminal device does not transmit the third information to the network device, the first switch period is determined using Scheme 1. That is, the network device indicates the first switch period to the terminal device.

The above method allows the terminal device to report to the network device whether the terminal device supports Scheme 1. This avoids situations where the terminal device does not support the first switch period indicated by the network device, thereby preventing inconsistencies between the terminal device and the network device regarding the first switch period.
Scheme 6: Supplement to Scheme 5

Scheme 5 is illustrated by using an example where the network device indicates the first switch period using Scheme 1. However, the network device may also indicate the first switch period to the terminal device using other schemes. In this embodiment, other possible approaches that may be used by the network device are exemplarily described hereinafter.

### Approach 1:

In some embodiments, the network device indicates the first switch period to the terminal device using a radio resource control (RRC) reconfiguration message.

In some embodiments, the RRC reconfiguration message is used to configure a band combination for the terminal device and carries a first switch period indicated to the terminal device.

In some embodiments, in the RRC reconfiguration message, the first switch period may be indicated by indicating a high-order band combination, or the first switch period may be directly indicated, which is not limited in the present disclosure.

Upon receiving the RRC reconfiguration message, the terminal device performs band switching based on the band combination configured in the RRC reconfiguration message.

In some embodiments, the terminal device reports whether it supports the first switch period indicated by the network device in an RRC reconfiguration complete message.

In some embodiments, in a case where the terminal device reports that it does not support the first switch period indicated by the network device, both the terminal device and the network device determines the first switch period using a default value.

In some embodiments, in a case where the terminal device does not report to the network device whether the terminal device supports the network device in indicating the first switch period, the network device considers that the terminal device supports the first switch period indicated by the network device, and the terminal device performs band switching using the first switch period indicated by the network device.

In some embodiments, in a case where the terminal device does not report to the network device whether the terminal device supports the network device in indicating the first switch period, the network device considers that the terminal device does not support the first switch period indicated by the network device. In this case, the terminal device and the network device may determine the first switch period using a default value; or the terminal device may report its preferred first switch period and determine the preferred first switch period as the first switch period to be used by the terminal device for band switching; or the terminal device reports its preferred first switch period, and the network device determines the first switch period to be used by the terminal device for band switching based on the preferred first switch period of the terminal device. For the specific method for determining the first switch period, reference may be made to the embodiments of Scheme 2 and Scheme 4 as described above, which is not elaborated herein.

### Approach 2:

In some embodiments, the terminal device may report whether it supports the first switch period indicated by the network device using UE capability information.

In some embodiments, the terminal device reports whether it supports Scheme 1 using UE capability information.

In some embodiments, the UE capability information may be reported per high-order band combination, per low-order band combination within a high-order band combination, or per UE, which is not limited in the present disclosure.

For example, the UE capability information is reported per high-order band combination. For example, the terminal device reports in the UE capability information that a high-order band combination A+B+C does not support a first switch period indicated by the network device, and a high-order band combination A+B+D supports the first switch period indicated by the network device.

For example, the UE capability information is reported per low-order band combination within a high-order band combination. For example, the terminal device reports in the UE capability information that within a high-order band combination A+B+C, a low-order band combination A+B supports the first switch period indicated by the network device, and a low-order band combination B+C does not support the first switch period indicated by the network device.

For example, the UE capability information is reported per UE. For example, the terminal device reports in the UE capability information that this terminal device supports the first switch period indicated by the network device, or the terminal device reports in the UE capability information that this terminal device does not support the first switch period indicated by the network device.

### Approach 3:

In some embodiments, the terminal device transmits fourth information to the network device, wherein the fourth information is used to indicate whether the terminal device supports all switch periods corresponding to the first band combination indicated in a plurality of high-order band combinations.

In some embodiments, the fourth information may be UE capability information, and the UE capability information is used to indicate whether the terminal device supports all switch periods corresponding to the first band combination indicated in the plurality of high-order band combinations.

In some embodiments, the terminal device may report fourth information to the network device, wherein the fourth information is used to indicate whether the terminal device supports switch periods indicated in all high-order band combinations reported by the terminal device. For example, the high-order band combinations reported by the terminal device include A+B+C, A+B+D, and E+F+G, and the fourth information is used to indicate whether the terminal device supports switch periods indicated in A+B+C, A+B+D, and E+F+G.

In some embodiments, the fourth information may also be used to indicate whether a particular low-order band combination supports the switch periods indicated in all high-order band combinations reported by the terminal device. For example, the high-order band combinations reported by the terminal device include A+B+C, A+B+D, and E+F+G, and the fourth information is used to indicate whether a low-order band combination A+B supports switch periods indicated in A+B+C, A+B+D, and E+F+G.

In some embodiments, the fourth information may also be used to indicate whether a particular low-order band combination supports switch periods indicated in all high-order band combinations (each of the high-order band combinations including this low-order band combination) reported by the terminal device. For example, the high-order band combinations reported by the terminal device include A+B+C, A+B+D, and E+F+G, and the fourth information is used to indicate whether a low-order band combination A+B supports switch periods indicated in A+B+C and A+B+D.

In some embodiments, in a case where the fourth information indicates that the terminal device supports all switch periods corresponding to the first band combination indicated in the plurality of high-order band combinations, the first switch period is determined based on first information that is transmitted by the network device, wherein the first information is used to indicate a first switch period determined by the network device.

In some embodiments, in a case where the fourth information indicates that the terminal device supports the switch periods indicated in all high-order band combinations reported by the terminal device, the first switch period corresponding to the low-order band combination may be determined using Scheme 1. For example, in a case where the fourth information indicates that the terminal device supports the switch periods indicated in all high-order band combinations reported by the terminal device, the network device determines, from all high-order band combinations reported by the terminal device, a switch period indicated in one of these high-order band combinations as the first switch period, and transmits first information to the terminal device, wherein the first information is used to indicate the first switch period determined by the network device.

In some embodiments, in a case where the fourth information indicates that the terminal device supports all switch periods corresponding to the first band combination indicated in the plurality of high-order band combinations, the first switch period is determined based on a default value.

In some embodiments, in a case where the fourth information indicates that the terminal device supports the switch periods indicated in all high-order band combinations reported by the terminal device, the first switch period corresponding to the low-order band combination may be determined using Scheme 3. For example, in a case where the fourth information indicates that the terminal device supports the switch periods indicated in all high-order band combinations reported by the terminal device, both the terminal device and the network device may determine the first switch period using the default value. For example, the terminal device and the network device determine a maximum switch period, from switch periods of the low-order band combination indicated in all high-order band combinations reported by the terminal device, as the first switch period.

In some embodiments, in a case where the fourth information indicates that the terminal device does not support all switch periods corresponding to the first band combination indicated in the plurality of high-order band combinations, the first switch period is determined based on a default value.

In some embodiments, in a case where the fourth information indicates that the terminal device does not support the switch periods indicated in all high-order band combinations reported by the terminal device, the first switch period corresponding to the low-order band combination may be determined using Scheme 3. In other words, the terminal device only supports switch periods indicated in some of the high-order band combinations reported by the terminal device. For example, in a case where the fourth information indicates that the terminal device does not support the switch periods indicated in all high-order band combinations reported by the terminal device, both the terminal device and the network device may determine the first switch period using a default value. For example, the terminal device and the network device determine a maximum switch period, from a plurality of candidate switch periods, as the first switch period. In a case where the plurality of candidate switch periods include 35 μs, 140 μs and 210 μs, both the terminal device and the network device determine the first switch period to be 210 μs.

In some embodiments, in a case where the fourth information indicates that the terminal device does not support all switch periods corresponding to the first band combination indicated in the plurality of high-order band combinations, the first switch period is determined based on a preferred first switch period of the terminal device.

In some embodiments, in a case where the fourth information indicates that the terminal device does not support the switch periods indicated in all high-order band combinations reported by the terminal device, the first switch period corresponding to the low-order band combination may also be determined using Scheme 2. In other words, the terminal device only supports switch periods indicated in some of the high-order band combinations reported by the terminal device. For example, in a case where the fourth information indicates that the terminal device does not support the switch periods indicated in all high-order band combinations reported by the terminal device, the terminal device transmits second information to the network device, wherein the second information is used to indicate a preferred first switch period of the terminal device. In some embodiments, the first switch period corresponding to the low-order band combination may also be determined using Scheme 4. For example, the terminal device transmits second information to the network device, wherein the second information is used to indicate a preferred first switch period of the terminal device, and the network device determines the first switch period to be used by the terminal device based on the preferred first switch period of the terminal device indicated in the second information, and transmits first information to the terminal device, wherein the first information is used to indicate a first switch period determined by the network device.

According to the above method, the terminal device and the network device may determine whether the terminal device supports the first switch period indicated by the network device, using the RRC reconfiguration message, the RRC reconfiguration complete message, and/or the UE capability information. This avoids inconsistencies between the terminal device and the network device regarding the first switch period.

Furthermore, the terminal device may indicate to the network device whether the terminal device supports switch periods of all low-order band combinations indicated in the reported plurality of high-order band combinations, and then select a scheme for determining the first switch period. This avoids inconsistencies between the terminal device and the network device regarding the first switch period, caused by the network device directly indicating the first switch period.

It should be noted that only several possible approaches are exemplarily described in the embodiments of the present disclosure. The network device may also indicate the first switch period using other messages, signaling or information, and the terminal device may also report whether it supports the first switch period indicated by the network device using other messages, signaling or information, which is not limited in the present disclosure.
Scheme 7: Combination of Scheme 1, Scheme 2 and Scheme 3

As illustrated in FIG. 17, Scheme 5 may involve step 750 and step 740.

In step 750, the terminal device transmits third information to the network device, wherein the third information is used to indicate whether the terminal device supports the network device in indicating a first switch period.

Correspondingly, the network device receives the third information that is transmitted by the terminal device.

In step 740, the terminal device transmits second information to the network device, wherein the second information is used to indicate a preferred first switch period of the terminal device.

Correspondingly, the network device receives the second information that is transmitted by the terminal device.

In some embodiments, in a case where the third information indicates that the terminal device supports the network device in indicating the first switch period and the terminal device does not transmit the second information, the first switch period is determined based on first information that is transmitted by the network device, wherein the first information is used to indicate a first switch period determined by the network device.

In some embodiments, in a case where the third information indicates that the terminal device supports the network device in indicating the first switch period and the terminal device does not transmit the second information, the first switch period is determined using Scheme 1. That is, the first switch period is determined according to the flowchart illustrated in FIG. 9.

In some embodiments, in a case where the third information indicates that the terminal device supports the network device in indicating the first switch period and the terminal device transmits the second information, the first switch period is determined based on first information that is transmitted by the network device, wherein the first information is used to indicate a first switch period determined by the network device. The first switch period indicated in the first information is determined based on the preferred first switch period of the terminal device indicated in the second information.

In some embodiments, in a case where the third information indicates that the terminal device supports the network device in indicating the first switch period and the terminal device transmits the second information, the first switch period is determined using Scheme 4. T hat is, the first switch period is determined according to the flowchart illustrated in FIG. 15.

In some embodiments, in a case where the terminal device does not transmit the third information to the network device, or the third information indicates that the terminal device does not support the network device in indicating the first switch period, and the terminal device does not transmit the second information to the network device, the first switch period is determined based on a default value.

In some embodiments, in a case where the terminal device does not transmit the third information to the network device, or the third information indicates that the terminal device does not support the network device in indicating the first switch period, and the terminal device does not transmit the second information to the network device, the first switch period is determined using Scheme 3. That is, both the terminal device and the network device determine the first switch period using a default value.

In some embodiments, in a case where the terminal device does not transmit the third information to the network device, or the third information indicates that the terminal device does not support the network device in indicating the first switch period, and the terminal device transmits the second information to the network device, the first switch period is autonomously determined by the terminal device. The network device determines the preferred first switch period of the terminal device indicated in the second information as the first switch period to be used by the terminal device.

A comprehensive method for determining the first switch period is provided above, which addresses potential issues that may arise during communication between the terminal device and the network device, and avoids inconsistencies between the terminal device and the network device regarding the first switch period.
Scheme 8: The first switch period is determined based on indication information reported by the terminal device.

In some embodiments, the terminal device transmits indication information to the network device, wherein the indication information is used to indicate whether the terminal device supports a switch period corresponding to a first band combination indicated in a high-order band combination corresponding to the indication information.

In some embodiments, the terminal device transmits indication information to the network device, wherein the indication information is used to indicate whether the terminal device supports a switch period indicated in the high-order band combination.

In some embodiments, the indication information is carried in first capability information transmitted by the terminal device, wherein the first capability information is used to indicate one or more high-order band combinations supported by the terminal device.

In some embodiments, low-order band combinations indicated in the indication information may be all of low-order band combinations included in the high-order band combination corresponding to the indication information, or part of the low-order band combinations included in the high-order band combination corresponding to the indication information. In some embodiments, the part of the low-order band combinations included in the high-order band combination may be any one of the low-order band combinations included in the high-order band combination, or a collection composed of any plurality of low-order band combinations included in the high-order band combination.

For example, a switch period of a low-order band combination A+B indicated by the terminal device in a high-order band combination A+B+C+D is 35 μs, and indication information, carried by the terminal device in first capability information corresponding to the high-order band combination A+B+C+D, indicates whether the terminal device supports performing band switching of the low-order band combination A+B at 35 μs within the low-order band combination. The indication information may be applicable to all low-order band combinations (e.g., band combinations A+B+C, A+B+D, and A+B), or to a single low-order band combination (e.g., band combination A+B+C, A+B+D, or A+B).

In some embodiments, different high-order band combinations correspond to different indication information. For example, the high-order band combination A+B+C corresponds to indication information 1, and the high-order band combination A+B+D corresponds to indication information 2.

In some embodiments, different bits or different fields in the indication information correspond to different high-order band combinations. For example, the 1^{st} and 2^{nd} bits in the indication information correspond to the high-order band combination A+B+C, and the 3^{rd} and 4^{th} bits correspond to the high-order band combination A+B+D.

In some embodiments, in a case where the indication information indicates that the terminal device supports the switch period corresponding to the first band combination indicated in the high-order band combination corresponding to the indication information, the first switch period is determined based on first information that is transmitted by the network device, wherein the first information is used to indicate a first switch period determined by the network device.

In some embodiments, upon acquiring capabilities of the terminal device for a high-order band combination, the network device determines whether the terminal device supports switch periods indicated in the high-order band combination, such that the first switch period may be determined using Scheme 1.

In some embodiments, in a case where the terminal device supports performing band switching within a low-order band combination based on a switch period indicated in a corresponding high-order band combination, the network device may determine the switch period indicated in the high-order band combination as the first switch period, and transmit first information to the terminal device, wherein the first information is used to indicate the first switch period determined by the network device.

In some embodiments, in a case where the indication information indicates that the terminal device supports the switch period corresponding to the first band combination indicated in the high-order band combination corresponding to the indication information, the first switch period is determined based on a default value. For example, the default value is a maximum switch period in switch periods indicated in the high-order band combinations supported by the terminal device.

In some embodiments, in a case where the indication information indicates that the terminal device does not support the switch period corresponding to the first band combination indicated in the high-order band combination corresponding to the indication information, the first switch period is determined based on a default value. The default value is defined without including the switch period corresponding to the first band combination indicated in the high-order band combination corresponding to the indication information.

In some embodiments, in a case where the terminal device does not support performing band switching within a low-order band combination based on a switch period indicated in a corresponding high-order band combination, the network device excludes the switch period indicated in the high-order band combination during determination of the first switch period. For example, switch periods of a low-order band combination A+B indicated in high-order band combinations A+B+C and A+B+D are 35 μs and 140 μs respectively, and the indication information indicates that the terminal device does not support the switch period indicated by the high-order band combination A+B+C, then the network device excludes 35 μs during determination of the first switch period.

In some embodiments, in a case where the terminal device does not support performing band switching within a low-order band combination based on a switch period indicated in a corresponding high-order band combination, the network device excludes the switch period not supported by the terminal device, and then may determine the first switch period using Scheme 3. For example, switch periods of a low-order band combination A+B indicated in high-order band combinations A+B+C and A+B+D are 35 μs and 140 μs respectively, and the indication information indicates that the terminal device does not support the switch period indicated by the high-order band combination A+B+C, then the network device excludes 35 μs during determination of the first switch period. In a case where a default value is a maximum switch period in switch periods indicated in the high-order band combinations reported by the terminal device, the network device may determine 140 μs as the first switch period. In a case where a default value is a maximum switch period in a plurality of candidate switch periods, and the plurality of candidate switch periods include 35 μs, 140 μs, and 210 μs, the network device may determine 210 μs as the first switch period.

In some embodiments, in a case where the terminal device does not report the indication information in the first capability information corresponding to the high-order band combination, the network device considers that the terminal device supports the switch period of the low-order band combination indicated in the high-order band combination.

In some embodiments, in a case where the terminal device does not report the indication information in the first capability information corresponding to the high-order band combination, the network device considers that the terminal device does not support the switch period of the low-order band combination indicated in the high-order band combination.

According to the above method, while reporting the capabilities for the high-order band combination to the network device, the terminal device also reports whether it supports the switch period of the low-order band combination indicated in the high-order combination. This enables the network device to determine the switch period unsupported by the terminal device for the low-order band combination. Consequently, the determined first switch period is prevented from being one unsupported by the terminal device, such that inconsistencies between the terminal device and the network device regarding the first switch period are avoided.

It should be noted that Scheme 4 to Scheme 8 merely illustrate possible combinations. The methods according to the embodiments of the present disclosure may also be combined to form other methods, and such combined methods shall also fall within the scope of protection of the embodiments of the present disclosure.

In the aforementioned method embodiments, the technical solutions of the present disclosure are introduced and explained only from the perspective of interaction between the terminal device and the network device. The above steps performed by the terminal device may be independently implemented as a method for determining a switch period between bands on the terminal device side, and the above steps performed by the network device may be independently implemented as a method for determining a switch period between bands on the network device side. In addition, the embodiments provided in the present disclosure may be combined arbitrarily to form new embodiments, all of which are within the protection scope of the present disclosure.

Device embodiments of the present disclosure are provided hereinafter, which are applicable for implementing the method embodiments of the present disclosure. For details not disclosed in the device embodiments of the present disclosure, reference may be made to the method embodiments of the present disclosure.

FIG. 18 is a block diagram of an apparatus for determining a switch period between bands according to some embodiments of the present disclosure. The apparatus has a function of implementing the examples of the above method for determining a switch period between bands. This functionality may be implemented by hardware or by hardware executing corresponding software. The apparatus may be the terminal device as described above, or may be configured within the terminal device. As illustrated in FIG. 18, the apparatus 1800 may include a processing module 1810.

The processing module 1810 is configured to determine a first switch period, wherein the first switch period is a switch period between a first band and a second band in the first band combination.

In some embodiments, the processing module 1810 is configured to determine the first switch period based on first information that is transmitted by a network device, wherein the first information is used to indicate a first switch period determined by the network device.

In some embodiments, the first information is used to indicate a first high-order band combination in the plurality of high-order band combinations, wherein the first high-order band combination includes the first band and the second band, and the first switch period determined by the network device is the same as a second switch period, the second switch period being a switch period between the first band and the second band in the first high-order band combination.

In some embodiments, the first information is used to indicate the first switch period determined by the network device from a plurality of candidate switch periods.

In some embodiments, the apparatus 1800 further includes a transmitting module (not shown).

The transmitting module is configured to transmit second information to the network device, wherein the second information is used to indicate a preferred first switch period of the terminal device.

In some embodiments, the second information is used to indicate a second high-order band combination in the plurality of high-order band combinations, wherein the second high-order band combination includes the first band and the second band, and the preferred first switch period of the terminal device is the same as a third switch period, the third switch period being a switch period between the first band and the second band in the second high-order band combination.

In some embodiments, the second information is used to indicate the preferred first switch period of the terminal device from a plurality of candidate switch periods.

In some embodiments, the first switch period determined by the network device is greater than or equal to the preferred first switch period of the terminal device.

In some embodiments, in a case where the terminal device fails to transmit the second information to the network device, the network device determines a switch period between the first band and the second band in any one of the plurality of high-order band combinations supported by the terminal device; or
in a case where the terminal device fails to transmit the second information to the network device, the first switch period is determined based on a default value.

In some embodiments, the transmitting module is further configured to transmit second information to a network device, wherein the second information is used to indicate the preferred first switch period of the terminal device.

In some embodiments, the second information is used to indicate a second high-order band combination in the plurality of high-order band combinations, wherein the second high-order band combination includes the first band and the second band, and the preferred first switch period of the terminal device is the same as a third switch period, the third switch period being a switch period between the first band and the second band in the second high-order band combination.

In some embodiments, the second information is used to indicate the preferred first switch period of the terminal device from a plurality of candidate switch periods.

In some embodiments, the processing module 1810 is configured to determine a default value as the first switch period.

In some embodiments, the default value is a maximum switch period between the first band and the second band in the plurality of high-order band combinations; or

the default value is a maximum switch period in a plurality of candidate switch periods.

In some embodiments, the transmitting module is further configured to transmit third information to a network device, wherein the third information is used to indicate whether the terminal device supports the network device in indicating the first switch period.

In some embodiments, in a case where the third information indicates that the terminal device supports the network device in indicating the first switch period, the first switch period is determined based on first information that is transmitted by the network device, wherein the first information is used to indicate a first switch period determined by the network device.

In some embodiments, in a case where the terminal device fails to transmit the third information to the network device, or in a case where the third information indicates that the terminal device fails to support the network device to indicate the first switch period, the first switch period is determined based on a default value.

In some embodiments, the transmitting module is further configured to transmit fourth information to a network device, wherein the fourth information is used to indicate whether the terminal device supports all switch periods corresponding to the first band combination indicated in the plurality of high-order band combinations.

In some embodiments, in a case where the fourth information indicates that the terminal device supports all switch periods corresponding to the first band combination indicated in the plurality of high-order band combinations, the first switch period is determined based on first information that is transmitted by the network device, wherein the first information is used to indicate a first switch period determined by the network device; or
in a case where the fourth information indicates that the terminal device supports all switch periods corresponding to the first band combination indicated in the plurality of high-order band combinations, the first switch period is determined based on a default value.

In some embodiments, in a case where the fourth information indicates that the terminal device fails to support all switch periods corresponding to the first band combination indicated in the plurality of high-order band combinations, the first switch period is determined based on a default value; or
in a case where the fourth information indicates that the terminal device fails to support all switch periods corresponding to the first band combination indicated in the plurality of high-order band combinations, the first switch period is determined based on a preferred first switch period of the terminal device.

In some embodiments, the transmitting module is further configured to transmit indication information to a network device, wherein the indication information is used to indicate whether the terminal device supports a switch period corresponding to the first band combination indicated in a high-order band combination corresponding to the indication information.

In some embodiments, in a case where the indication information indicates that the terminal device supports the switch period corresponding to the first band combination indicated in the high-order band combination corresponding to the indication information, the first switch period is determined based on first information that is transmitted by the network device, wherein the first information is used to indicate a first switch period determined by the network device.

In some embodiments, in a case where the indication information indicates that the terminal device fails to support the switch period corresponding to the first band combination indicated in the high-order band combination corresponding to the indication information, the first switch period is determined based on a default value.

The technical solutions according to the embodiments of the present disclosure provide a method for determining a first switch period used for band switching in a low-order band combination in a case where the terminal device reports different switch periods in a plurality of high-order band combinations for the same low-order band combination. This ensures that band switching is performed normally to guarantee communication quality.

FIG. 19 is a block diagram of an apparatus for determining a switch period between bands according to some embodiments of the present disclosure. The apparatus has a function of implementing the examples of the above method for determining a switch period between bands. This functionality may be implemented by hardware or by hardware executing corresponding software. The apparatus may be the network device as described above, or may be configured within the network device. As illustrated in FIG. 19, the apparatus 1900 may include: a processing module 1910.

The processing module 1910 is configured to determine a first switch period to be used by a terminal device, wherein the terminal device supports a first band combination and a plurality of high-order band combinations corresponding to the first band combination; and the first switch period is a switch period between a first band and a second band in the first band combination.

In some embodiments, the apparatus further includes a transmitting module (not illustrated).

The transmitting module is configured to transmit first information to the terminal device, wherein the first information is used to indicate a first switch period determined by the network device.

In some embodiments, the first information is used to indicate a first high-order band combination in the plurality of high-order band combinations, wherein the first high-order band combination includes the first band and the second band, and the first switch period determined by the network device is the same as a second switch period, the second switch period being a switch period between the first band and the second band in the first high-order band combination.

In some embodiments, the first information is used to indicate the first switch period determined by the network device from a plurality of candidate switch periods.

In some embodiments, the apparatus further includes a receiving module (not shown).

The receiving module is configured to receive second information that is transmitted by the terminal device, wherein the second information is used to indicate a preferred first switch period of the terminal device.

In some embodiments, the second information is used to indicate a second high-order band combination in the plurality of high-order band combinations, wherein the second high-order band combination includes the first band and the second band, and the preferred first switch period of the terminal device is the same as a third switch period, the third switch period being a switch period between the first band and the second band in the second high-order band combination.

In some embodiments, the second information is used to indicate the preferred first switch period of the terminal device from a plurality of candidate switch periods.

In some embodiments, the first switch period determined by the network device is greater than or equal to the preferred first switch period of the terminal device.

In some embodiments, in a case where the terminal device fails to transmit the second information to the network device, the network device determines a switch period between the first band and the second band in any one of the plurality of high-order band combinations supported by the terminal device; or
in a case where the terminal device fails to transmit the second information to the network device, the first switch period to be used by the terminal device is determined based on a default value.

In some embodiments, the first switch period to be used by the terminal device is a preferred first switch period of the terminal device, and the receiving module is further configured to receive second information that is transmitted by the terminal device, wherein the second information is used to indicate the preferred first switch period of the terminal device.

In some embodiments, the second information is used to indicate a second high-order band combination in the plurality of high-order band combinations, wherein the second high-order band combination includes the first band and the second band, and the preferred first switch period of the terminal device is the same as a third switch period, the third switch period being a switch period between the first band and the second band in the second high-order band combination.

In some embodiments, the second information is used to indicate the preferred first switch period of the terminal device from a plurality of candidate switch periods.

In some embodiments, the processing module 1910 is configured to determine a default value as the first switch period to be used by the terminal device.

In some embodiments, the default value is a maximum switch period between the first band and the second band in the plurality of high-order band combinations; or
the default value is a maximum switch period in a plurality of candidate switch periods.

In some embodiments, the receiving module is further configured to receive third information that is transmitted by the terminal device, wherein the third information is used to indicate whether the terminal device supports the network device in indicating the first switch period.

In some embodiments, in a case where the third information indicates that the terminal device supports the network device in indicating the first switch period, the first switch period to be used by the terminal device is determined based on first information that is transmitted by the network device, wherein the first information is used to indicate a first switch period determined by the network device.

In some embodiments, in a case where the terminal device fails to transmit the third information to the network device, or in a case where the third information indicates that the terminal device fails to support the network device to indicate the first switch period, the first switch period to be used by the terminal device is determined based on a default value.

In some embodiments, the receiving module is further configured to receive fourth information that is transmitted by the terminal device, wherein the fourth information is used to indicate whether the terminal device supports all switch periods corresponding to the first band combination indicated in the plurality of high-order band combinations.

In some embodiments, in a case where the fourth information indicates that the terminal device supports all switch periods corresponding to the first band combination indicated in the plurality of high-order band combinations, the first switch period is determined based on first information that is transmitted by the network device, wherein the first information is used to indicate a first switch period determined by the network device; or
in a case where the fourth information indicates that the terminal device supports all switch periods corresponding to the first band combination indicated in the plurality of high-order band combinations, the first switch period is determined based on a default value.

In some embodiments, in a case where the fourth information indicates that the terminal device fails to support all switch periods corresponding to the first band combination indicated in the plurality of high-order band combinations, the first switch period is determined based on a default value; or
in a case where the fourth information indicates that the terminal device fails to support all switch periods corresponding to the first band combination indicated in the plurality of high-order band combinations, the first switch period is determined based on a preferred first switch period of the terminal device.

In some embodiments, the receiving module is further configured to receive indication information that is transmitted by the terminal device, wherein the indication information is used to indicate whether the terminal device supports a switch period corresponding to the first band combination indicated in a high-order band combination corresponding to the indication information.

In some embodiments, in a case where the indication information indicates that the terminal device supports the switch period corresponding to the first band combination indicated in the high-order band combination corresponding to the indication information, the first switch period is determined based on first information that is transmitted by the network device, wherein the first information is used to indicate a first switch period determined by the network device.

In some embodiments, in a case where the indication information indicates that the terminal device fails to support the switch period corresponding to the first band combination indicated in the high-order band combination corresponding to the indication information, the first switch period is determined based on a default value.

The technical solutions according to the embodiments of the present disclosure provide a method for the network device to determine a first switch period in a case where the terminal device reports different switch periods in a plurality of high-order band combinations for the same low-order band combination. This ensures the consistency between the terminal device and the network device in determining the first switch period.

It should be noted that, in implementing functions, the apparatus provided in the above embodiments is only described by way of example based on the division of the above functional modules. In practical applications, the above functions may be allocated to and accomplished by different functional modules as needed. That is, the internal structure of the apparatus may be divided into different functional modules to perform all or part of the functions described above.

The specific ways in which each module in the apparatus of the above embodiments performs operations are described in detail in the embodiments related to the method, and are not elaborated herein.

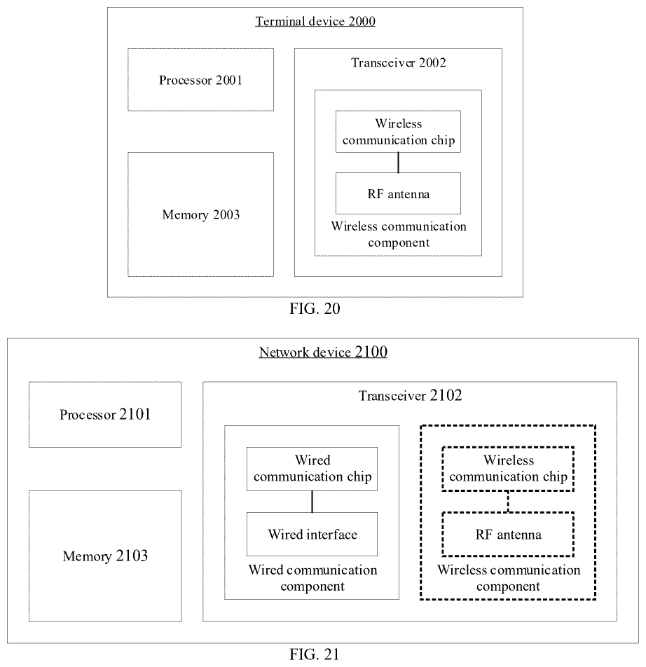

FIG. 20 is a schematic structural diagram of a terminal device 2000 according to some embodiments of the present disclosure. The terminal device 2000 may include: a processor 2001, a transceiver 2002, and a memory 2003. The transceiver 2002 is configured to implement the transmitting or receiving function. The processor 2001 may be configured to implement other processing functions or to control transmission and/or reception, such as implementing the function of the processing module 1810 as described above.

The processor 2001 includes one or more processing cores. The processor 2001 executes various functional applications and performs information processing by running software programs and modules.

The transceiver 2002 may include a receiver and a transmitter. For example, the receiver and the transmitter may be implemented as the same wireless communication component, which may include a wireless communication chip and an RF antenna.

The memory 2003 may be communicably connected to the processor 2001 and the transceiver 2002.

The memory 2003 may be configured to store one or more computer programs run by the processor. The one or more computer programs, when run by the processor 2001, cause the processor 2001 to perform the steps in the above method embodiments.

In some embodiments, the processor 2001 is configured to determine a first switch period, wherein the first switch period is a switch period between a first band and a second band in a first band combination.

For details not elaborated in the embodiments, reference may be made to the preceding embodiments, which are not repeated herein.

In addition, the memory may be implemented by any type of a volatile or non-volatile storage device or a combination thereof. The volatile or non-volatile storage device includes, but not limited to: a magnetic or optical disk, an electrically-erasable programmable read-only memory (EEPROM), an erasable programmable read-only memory (EPROM), a static random-access memory (SRAM), a read-only memory (ROM), a magnetic memory, a flash memory, and a programmable ROM (PROM).

FIG. 21 is a schematic structural diagram of a network device 2100 according to some embodiments of the present disclosure. The network device 2100 may include a processor 2101, a transceiver 2102, and a memory 2103. The processor 2101 is configured to implement the function of the processing module 1910 as described above.

The processor 2101 includes one or more processing cores. The processor 2101 executes various functional applications and performs information processing by running software programs and modules. The processor 2101 is configured to perform steps other than the transmitting and receiving steps performed by the network device in the above method embodiments.

The transceiver 2102 may include a receiver and a transmitter. For example, the receiver and the transmitter may be implemented as the same wireless communication component, and the wireless communication component may include a wireless communication chip and an RF antenna. The transceiver 2102 is configured to perform the transmitting and/or receiving steps performed by the network device in the above method embodiments.

The memory 2103 may be communicably connected to the processor 2101 and the transceiver 2102.

The memory 2103 may be configured to store one or more computer programs run by the processor. The one or more computer programs, when run by the processor 2101, cause the processor 2101 to perform steps in the above method embodiments.

In addition, the memory may be implemented by any type of a volatile or non-volatile storage device or a combination thereof. The volatile or non-volatile storage device includes, but not limited to: a magnetic or optical disk, an EEPROM, an EPROM, an SRAM, a ROM, a magnetic memory, a flash memory, and a PROM.

In some embodiments, the processor 2101 is configured to determine a first switch period to be used by a terminal device, wherein the terminal device supports a first band combination and a plurality of high-order band combinations corresponding to the first band combination; and the first switch period is a switch period between a first band and a second band in the first band combination.

For details not elaborated in the embodiments, reference may be made to the preceding embodiments, which are not repeated herein.

Some embodiments of the present disclosure further provide a computer-readable storage medium. The storage medium stores one or more computer programs. The one or more computer programs, when run by a processor, cause the processor to perform the method for determining a switch period between bands on the terminal device side or the method for determining a switch period between bands on the network device side as described above. In some embodiments, the computer-readable storage medium may include a ROM, a random-access memory (RAM), a solid state drive (SSD), or an optical disk, or the like. The RAM may include a resistance RAM (ReRAM) and a dynamic RAM (DRAM).

Some embodiments of the present disclosure further provide a chip. The chip includes programmable logic circuitry and/or one or more program instructions. The chip, when running, is configured to perform the method for determining a switch period between bands on the terminal device side or the method for determining a switch period between bands on the network device side as described above.

Some embodiments of the present disclosure further provide a computer program product. The computer program product includes one or more computer programs stored in a computer-readable storage medium, wherein the one or more computer programs, when loaded from the computer-readable storage medium and run by a processor, cause the processor to perform the method for determining a switch period between bands on the terminal device side or the method for determining a switch period between bands on the network device side as described above.

It should be understood that the term “indication” mentioned in the embodiments of the present disclosure may be a direct indication, an indirect indication, or an indication that an association relationship is present. For example, “A indicates B” may mean that A directly indicates B, for example, B may be obtained through A; or may mean that A indirectly indicates B, for example, A indicates C through which B may be obtained; or may mean an association relationship is present between A and B.

In the description of the embodiments of the present disclosure, the term “corresponding” may indicate a direct corresponding relationship or an indirect corresponding relationship between two items, or an association relationship between the two items, or a relationship such as indicating and being indicated, configuring and being configured, or the like.

In the embodiments of the present disclosure, a “predefined” or “preconfigured” operation may be performed by pre-storing corresponding codes or tables in a device (e.g., a device including a terminal device and a network device), or may be performed by other means that may be used to indicate relevant information. The present disclosure does not impose any restrictions on specific methods for performing the predefined or preconfigured operation. For example, the predefined operation may be stipulated in a protocol.

In the embodiments of the present disclosure, the “protocol” may refer to a standard protocol in the communication field. For example, the protocol may include an LTE protocol, an NR protocol, and related protocols applied in future communication systems, which is not limited in the present disclosure.

The term “a plurality of” herein means two or more. The term “and/or” describes an association relationship of associated objects, and it indicates three types of relationships. For example, the phrase “A and/or B” means (A), (B), or (A and B). The character “/” usually indicates an “or” relationship between the associated objects.

The phrase “greater than or equal to” herein may refer to either “greater than or equal to” or strictly “greater than;” similarly, “less than or equal to” may refer to either “less than or equal to” or strictly “less than.”

In addition, the serial numbers of the steps described herein only exemplifies one possible execution sequence among the steps. In some embodiments, the above steps may also be executed without following the numbering sequence. For example, two steps with different serial numbers are executed simultaneously or in an order reverse to the order shown in the figures. This is not limited in the embodiments of the present disclosure.

A person skilled in the art should be aware that in the foregoing one or more examples, the functions described in the embodiments of the present disclosure may be implemented by hardware, software, firmware, or any combination thereof. The functions, when implemented by software, may be stored in a computer-readable medium or transmitted as at least one instruction or code on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are merely exemplary embodiments of the present disclosure and are not intended to limit the present disclosure. Any modification, equivalent replacement, and improvement, and the like, made within the spirit and principle of the present disclosure shall be fall within the protection scope of the present disclosure.

1. A method for determining a switch period between bands, performed by a terminal device, wherein the terminal device supports a first band combination and a plurality of high-order band combinations corresponding to the first band combination, the method comprising:
determining a first switch period, wherein the first switch period is a switch period between a first band and a second band in the first band combination.

2. The method according to claim 1, wherein determining the first switch period comprises:
determining the first switch period based on first information that is transmitted by a network device, wherein the first information is used to indicate a first switch period determined by the network device.

3. The method according to claim 2, wherein the first information is used to indicate a first high-order band combination in the plurality of high-order band combinations, wherein the first high-order band combination comprises the first band and the second band, and the first switch period determined by the network device is the same as a second switch period, the second switch period being a switch period between the first band and the second band in the first high-order band combination; or
the first information is used to indicate the first switch period determined by the network device from a plurality of candidate switch periods.

4. The method according to claim 2, wherein prior to determining the first switch period based on the first information that is transmitted by the network device, the method further comprises:
transmitting second information to the network device, wherein the second information is used to indicate a preferred first switch period of the terminal device.

5. The method according to claim 4, wherein the second information is used to indicate a second high-order band combination in the plurality of high-order band combinations, wherein the second high-order band combination comprises the first band and the second band, and the preferred first switch period of the terminal device is the same as a third switch period, the third switch period being a switch period between the first band and the second band in the second high-order band combination; or
the second information is used to indicate the preferred first switch period of the terminal device from a plurality of candidate switch periods.

6. The method according to claim 4, wherein in a case where the terminal device fails to transmit the second information to the network device,
a switch period between the first band and the second band in any one of the plurality of high-order band combinations is supported by the terminal device; or
the first switch period is determined based on a default value.

7. The method according to claim 1, wherein the determined first switch period is a preferred first switch period of the terminal device; and upon determining the first switch period, the method further comprises:
transmitting second information to a network device, wherein the second information is used to indicate the preferred first switch period of the terminal device.

8. The method according to claim 1, wherein determining the first switch period comprises:
determining a default value as the first switch period, wherein the default value is:
a maximum switch period between the first band and the second band in the plurality of high-order band combinations; or
a maximum switch period in a plurality of candidate switch periods.

9. A communication device, comprising:
a processor; and
a memory storing one or more computer programs;
wherein the communication device supports a first band combination and a plurality of high-order band combinations corresponding to the first band combination; and the one or more programs, when executed by the processor, cause the processor to determine a first switch period, wherein the first switch period is a switch period between a first band and a second band in the first band combination.

10. The communication device according to claim 9, wherein the one or more programs, when executed by the processor, further cause the processor to:
transmit third information to a network device, wherein the third information is used to indicate whether the communication device supports the network device in indicating the first switch period.

11. The communication device according to claim 10, wherein:
in a case where the third information indicates that the communication device supports the network device in indicating the first switch period, the first switch period is determined based on first information that is transmitted by the network device, wherein the first information is used to indicate a first switch period determined by the network device; or
in a case where the communication device fails to transmit the third information to the network device, or in a case where the third information indicates that the communication device fails to support the network device to indicate the first switch period, the first switch period is determined based on a default value.

12. The communication device according to claim 9, wherein the one or more programs, when executed by the processor, further cause the processor to:
transmit fourth information to a network device, wherein the fourth information is used to indicate whether the communication device supports all switch periods corresponding to the first band combination indicated in the plurality of high-order band combinations.

13. The communication device according to claim 12, wherein:
in a case where the fourth information indicates that the communication device supports all switch periods corresponding to the first band combination indicated in the plurality of high-order band combinations,
the first switch period is determined based on first information that is transmitted by the network device, wherein the first information is used to indicate a first switch period determined by the network device; or
the first switch period is determined based on a default value; or
in a case where the fourth information indicates that the communication device fails to support all switch periods corresponding to the first band combination indicated in the plurality of high-order band combinations,
the first switch period is determined based on a default value; or
the first switch period is determined based on a preferred first switch period of the communication device.

14. The communication device according to claim 9, wherein the one or more programs, when executed by the processor, further cause the processor to:
transmit indication information to a network device, wherein the indication information is used to indicate whether the communication device supports a switch period corresponding to the first band combination indicated in a high-order band combination corresponding to the indication information.

15. The communication device according to claim 14, wherein:
in a case where the indication information indicates that the communication device supports the switch period corresponding to the first band combination indicated in the high-order band combination corresponding to the indication information, the first switch period is determined based on first information that is transmitted by the network device, wherein the first information is used to indicate a first switch period determined by the network device; or
in a case where the indication information indicates that the communication device fails to support the switch period corresponding to the first band combination indicated in the high-order band combination corresponding to the indication information, the first switch period is determined based on a default value.

16. A communication device, comprising:
a processor; and
a memory storing one or more computer programs,
wherein the one or more programs, when executed by the processor, cause the processor to determine a first switch period to be used by a terminal device, wherein the terminal device supports a first band combination and a plurality of high-order band combinations corresponding to the first band combination; and the first switch period is a switch period between a first band and a second band in the first band combination.

17. The communication device according to claim 16, wherein the one or more programs, when executed by the processor, further cause the processor to:
transmit first information to the terminal device, wherein the first information is used to indicate a first switch period determined by a network device.

18. The communication device according to claim 17, wherein the one or more programs, when executed by the processor, further cause the processor to:
receive second information that is transmitted by the terminal device, wherein the second information is used to indicate a preferred first switch period of the terminal device.

19. The communication device according to claim 16, wherein the first switch period to be used by the terminal device is a preferred first switch period of the terminal device; and the one or more programs, when executed by the processor, further cause the processor to:
receive second information that is transmitted by the terminal device, wherein the second information is used to indicate the preferred first switch period of the terminal device.

20. The communication device according to claim 16, wherein the one or more programs, when executed by the processor, further cause the processor to:
determine a default value as the first switch period to be used by the terminal device.
